(19) United States
(12) Patent Application Publication
(10) Pub. No.: US 2019/0325031 A1
(43) Pub. Date: Oct. 24, 2019

(54) MACHINE LEARNING BASED PREDICTIVE DOCUMENT SEARCHING SYSTEMS AND METHODS

(71) Applicant: Open Text Holdings, Inc., Wilmington, DE (US)

(72) Inventor: Jan Puzicha, Bonn (DE)

(21) Appl. No.: 15/957,685

(22) Filed: Apr. 19, 2018

(51) Int. Cl. G06F 17/30; G06N 99/00

(52) U.S. Cl. CPC G06F 17/30011; G06F 17/30598; G06N 99/005; G06F 17/30554; G06F 17/3053

(57) ABSTRACT

Machine learning based predictive document searching systems and methods are disclosed herein. An example method includes displaying on a graphical user interface a list of predictively coded documents; receiving an indication that a portion of the list of predictively coded documents are relevant to a user, the indication including a pinning of the portion of the list of predictively coded documents through user actuation received through the graphical user interface, displaying the pinned portion of the list of predictively coded documents in a pinned document list, applying text categorization to the pinned portion of the list of predictively coded documents, obtaining a recommended set of documents from a corpus of documents based on the text categorization and displaying recommended set of documents to the user on the graphical user interface.

### CROSS REFERENCE TO RELATED APPLICATIONS

This application is related to U.S. patent application Ser. No. 15/406,542 entitled “Systems and Methods for Predictive Coding”, filed on Jan. 13, 2017, which is a continuation and claims the priority benefit of U.S. patent application Ser. No. 13/848,023, filed Mar. 20, 2013, now U.S. Pat. No. 9,595,005, which is a continuation of U.S. patent application Ser. No. 13/624,854, filed Sep. 21, 2012, now U.S. Pat. No. 8,489,538, which is a continuation of U.S. patent application Ser. No. 13/074,005, filed Mar. 28, 2011, now U.S. Pat. No. 8,554,716, which is a continuation of U.S. patent application Ser. No. 12/787,354, filed May 25, 2010, now U.S. Pat. No. 7,933,859. The disclosures of the aforementioned applications are incorporated by reference herein for all purposes, including all references and appendices cited therein.

### FIELD OF THE PRESENT TECHNOLOGY

The present technology relates generally to automatic document coding, and more specifically, but not by limitation, to systems and methods that provide machine learning based predictive document searching. These systems and methods allow for integrating user feedback on a searched document in order to search for additional relevant documents and iteratively refine recommended document sets.

### SUMMARY

Various embodiments of the present technology include a method comprising: displaying on a graphical user interface, a list of predictively coded documents; receiving an indication that a portion of the list of predictively coded documents are relevant to a user, the indication comprising a pinning of the portion of the list of predictively coded documents through user actuation received through the graphical user interface; displaying the pinned portion of the list of predictively coded documents in a pinned document list; applying text categorization to the pinned portion of the list of predictively coded documents; obtaining a recommended set of documents from a corpus of documents based on the text categorization; and displaying the recommended set of documents to the user on the graphical user interface.

Various embodiments of the present technology include a system comprising: a processor; and a memory for storing executable instructions, the processor executing the instructions to: display on a graphical user interface, a list of predictively coded documents; receive an indication that a portion of the list of predictively coded documents are relevant to a user, the indication comprising a pinning of the portion of the list of predictively coded documents through user actuation received through the graphical user interface; display the pinned portion of the list of predictively coded documents in a pinned document list; obtain a recommended set of documents from a corpus of documents based on text categorization; and display the recommended set of documents to the user on the graphical user interface.

Various embodiments of the present technology include a method comprising: displaying on a graphical user interface, a list of predictively coded documents; receiving an indication that a portion of the list of predictively coded documents are relevant to a user, the indication comprising a selection of the portion of the list of predictively coded documents through user actuation received through the graphical user interface; displaying the selected portion of the list of predictively coded documents in a selected document list; applying text categorization to the selected portion of the list of predictively coded documents; obtaining a recommended set of documents from a corpus of documents based on the text categorization; and displaying the recommended set of documents to the user on the graphical user interface.

### BRIEF DESCRIPTION OF THE DRAWINGS

Certain embodiments of the present technology are illustrated by the accompanying figures. It will be understood that the figures are not necessarily to scale and that details not necessary for an understanding of the technology or that render other details difficult to perceive may be omitted. It will be understood that the technology is not necessarily limited to the particular embodiments illustrated herein.

FIG. 1 is a flowchart of an example method of the present disclosure.

FIG. 2 is another flowchart of an example method of the present disclosure.

FIG. 3A-E screenshots of GUIs in the form of a document recommendation platform that collectively illustrate usage thereof.

FIG. 4 is a diagrammatic representation of an example machine in the form of a computer system.

### DETAILED DESCRIPTION

The present disclosure is directed to various embodiments of systems and methods that provide machine learning based predictive document searching. These systems and methods allow for integrating user feedback on a searched document in order to search for additional relevant documents and iteratively refine recommended document sets.

In more detail, an example system can be configured to display on a graphical user interface, a list of predictively coded documents. The system can then receive an indication that a portion of the list of predictively coded documents is relevant to a user. In some embodiments the indication comprises pinning of the portion of the list of predictively coded documents through user actuation received through the graphical user interface. In one or more embodiments, the systems can be configured to display the pinned portion of the list of predictively coded documents in a pinned document list, as well as obtain a recommended set of documents from a corpus of documents based on text categorization. Ultimately the system will then display a recommended set of documents to the user on the graphical user interface.

For context, the systems and methods herein provide a technical solution to a technical problem that frequently is faced by users who review automated document review systems, for example, an eDiscovery system. While eDiscovery systems are contemplated, the solutions provided herein can be utilized in other similar document analysis systems.

The solutions provided herein assist a researcher in their duties by providing systems that use machine learning to suggest documents that might not have been found otherwise. In general, as a user reviews a current set of research documents (e.g., found as a part of a predictive coding process), the user can review and select certain documents as relevant. These selected or “pinned” documents are used as input to determine what other documents in a corpus of documents might be of interest to the user. In some embodiments, the documents provided to the system need not be predictively coded, but are otherwise text searched. To be sure, in some embodiments documents are pinned by a reviewer through the use of a user interface, examples of which are disclosed herein. In other embodiments, rather than pinning, a reviewer can otherwise select documents using other means that would be known to one of ordinary skill in the art with the present disclosure before them. The selection of documents indicates that the documents are of particular relevance to the reviewer.

For example, using the systems and methods provided herein, the user can construct and execute keyword searches. The systems disclosed herein can return relevant documents to the keyword searches. The user can begin to review these documents. As the user finds documents of interest, the user can pin the document, which can result in the document being placed into a pinned list or queue.

The user can perform one or more keyword searches and select relevant documents to place into the pinned queue, if desired. When one or more documents have been placed in the pinned queue, an example system of the present disclosure can use these documents as the basis for performing a recommendation search for other documents in the corpus that are similar to that of the pinned documents. Additional information on the recommendation search is provided in greater detail infra.

When documents are found based on the recommendation search, these documents can be presented to the user. The user can look at the suggested documents and approve or suggest each on a document-by-document basis. As user feedback is received, both positive and negative, an example system of the present disclosure can utilize this feedback to find additional or different documents in an iterative manner. The user can continue to use interfaces of the present disclosure to refine recommended document sets. These and other advantages of the present disclosure are provided below in greater detail.

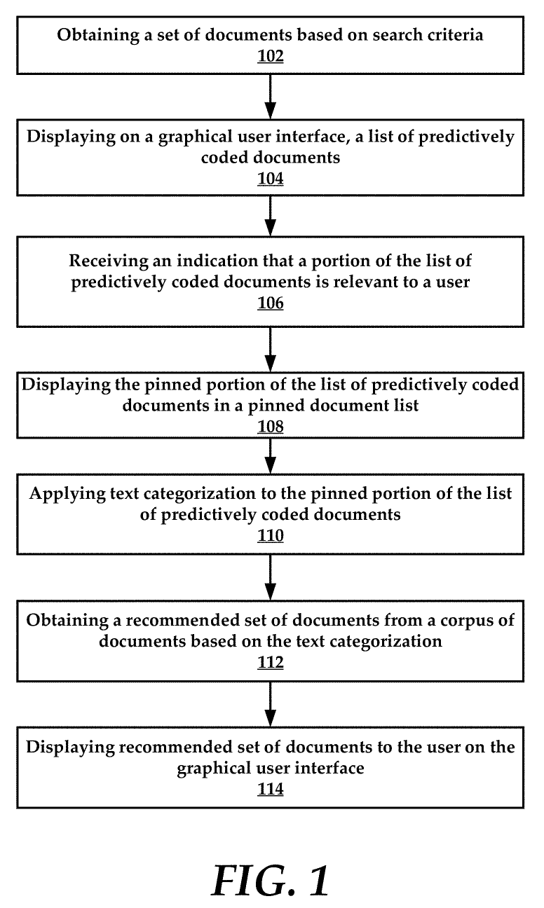

FIG. 1 is a flowchart of an example method of the present disclosure. The method generally involves an automated, feedback driven document recommendation process. The method is a GUI driven process where a reviewer is enabled to set forth a search query for documents using one or more document filters. The filters are used by the system to select relevant documents of interest to the reviewer. During review of these relevant documents, the GUI enables the reviewer to pin one or more of the relevant documents of interest. These documents are then added to a pinned document queue on the GUI. The reviewer can then cause the system to retrieve recommended documents based on the documents in the pinned document queue. Further document iteration is also an optional feature.

In more detail, the method includes a step 102 of obtaining a set of documents. This process includes searching a corpus of documents for entries that match one or more search criteria established by a reviewer. That is, the user defines parameters of documents of interest. The system uses these parameters to obtain documents from a corpus of documents.

In some embodiments, this searching process is performed using keyword searching for matching documents from a corpus. In one or more embodiments, the documents comprise predictively coded documents such that the set of documents that is returned includes a list of predictively coded documents. The predictive coding of documents is described in greater detail in U.S. application Ser. No. 15/406,542, entitled “Systems and Methods for Predictive Coding”, filed on Jan. 13, 2017, which is incorporated by reference herein in its entirety.

The method can also include a step 104 of displaying on a graphical user interface, a list of predictively coded documents. Again, these predictively coded documents were based on a keyword or term search of a document corpus. Again, the documents need not be predictively coded in some instances, but may include documents that match the keyword search performed using other matching methods.

In some embodiments, the method includes a step 106 of receiving an indication that a portion of the list of predictively coded documents is relevant to a user. As noted throughout, the indication can include a pinning of the portion of the list of predictively coded documents through user actuation received through the graphical user interface. For example if the system returns a list of ten predictively coded documents, the reviewer may determine that three of the ten documents are relevant and that the reviewer would like to find additional documents from the corpus that are similar to those documents.

Once the reviewer pins one or more documents, the method includes a step 108 of displaying the pinned portion of the list of predictively coded documents in a pinned document list. The GUI mentioned above includes a dedicated section or panel where pinned documents are listed.

Once at least one pinned document is placed into the pinned document list, the method can include a process of obtaining a recommended set of documents from the corpus based on the pinned documents. That is, the pinned documents serve as an input set for locating the recommended set of documents.

In some embodiments, this is performed using text categorization. In more detail, text categorization includes creating and applying a statistical classifier. The statistical classifier is trained on both positive and negative examples as indicated by a reviewer. Additional details on text categorization are provided infra.

Thus, the method includes a step 110 of applying text categorization to the pinned portion of the list of predictively coded documents, as well as a step 112 of obtaining a recommended set of documents from a corpus of documents based on the text categorization.

In more detail, this recommended set of documents is obtained using a statistical classifier that is trained on positive documents and/or positive and negative documents. For example, when the reviewer is presented with a set of recommended documents, the reviewer can review the recommended documents and make judgements about those documents. For example, the reviewer determines if the recommended documents are actually relevant to their interest. If not, the reviewer can indicate negatively that the document is not relevant by removing the document from the recommended documents list. Conversely, the reviewer can indicate that a recommended document is relevant by pinning the document. The document is then added to the pinned document queue or list.

In some embodiments, the method includes a step 114 of displaying a recommended set of documents to the user on the graphical user interface. This can include also displaying the pinned documents both from the set of documents obtained from the initial keyword search and from documents pinned from the recommended document set.

In general, the systems and methods herein rely on the use of text categorization in order to compare and recommend documents. In some embodiments, text categorization depends on a number of positive documents available. If this number is above a threshold a support vector machine algorithm is utilized. If the number of positive documents available is below the stated threshold, the systems and methods use a centrate based classifier that generates a representation across a subset of documents. This representation is an amalgamation or aggregation of the positive documents as a “super document” or collection. The classifier then computes distances between documents in the corpus and the super document. Documents that are determined to be close in distance to the super document are recommended. To be sure, the sensitivity of the distance used by the centrate based classifier is selectable based on design and performance requirements that are user-specified, in some embodiments.

With respect to the statistical classifier implemented in some embodiments, the statistical classifier predicts documents a reviewer might be interested in based on an ordering of the corpus of documents using predictive analysis. In some embodiments, the statistical classifier calculates and uses an internal probability score.

In one or more embodiments, the systems and methods herein can utilize the pinning of documents across a set of reviewers to assist in recommending documents to the reviewer. The more a document has been pinned across a set of reviewers, the more likely it is to be suggested to reviewers in the future.

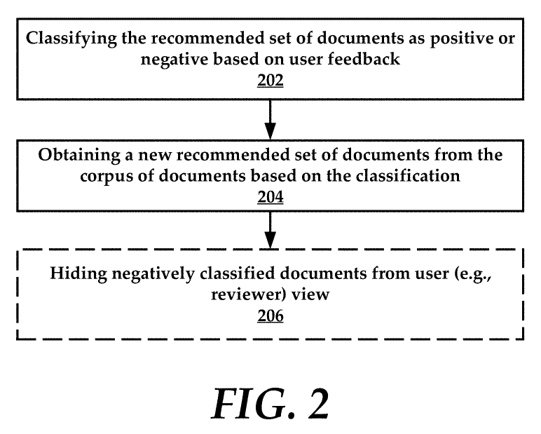

FIG. 2 is a flowchart of an example method of the present disclosure. In general, the method includes a process of iterative refinement of recommended documents using classification and reviewer feedback.

In some embodiments, the method can include a step 202 of classifying the recommended set of documents as positive or negative based on user feedback. For example, if the reviewer pins one of the documents in the recommended set, the document is considered to be a positive feedback instance. If the reviewer removes a document from the recommended set, the document is considered to be a negative feedback instance.

Once the reviewer has provided feedback on the recommended set, the method includes a step 204 of obtaining a new recommended set of documents from the corpus of documents based on the classification.

As noted above, the statistical classifier obtains the new recommended set of documents using both the positive and negative user feedback. Further, the statistical classifier obtains the new recommended set of documents by predicting what documents are relevant based on an ordering of documents in a corpus based on a probability score.

In one or more embodiments, the method includes a step 206 of hiding negatively classified documents from user (e.g., reviewer) view. The pinned documents (e.g., positive feedback) are used as further input into the system. As new documents are pinned, the statistical classifier algorithm is fine tuned to obtain even more relevant documents for the reviewer.

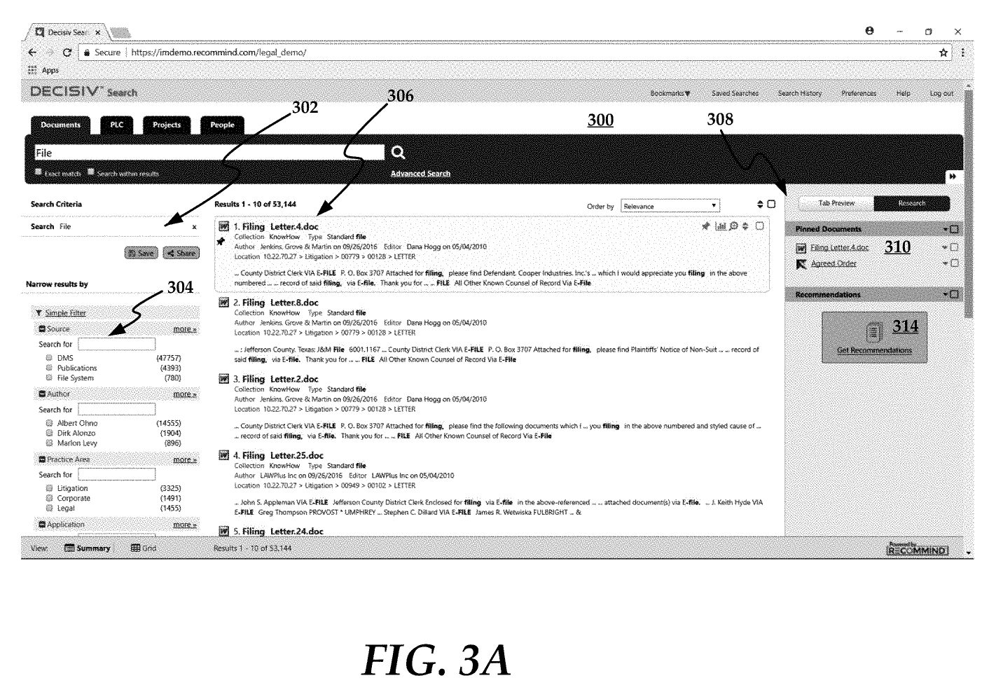

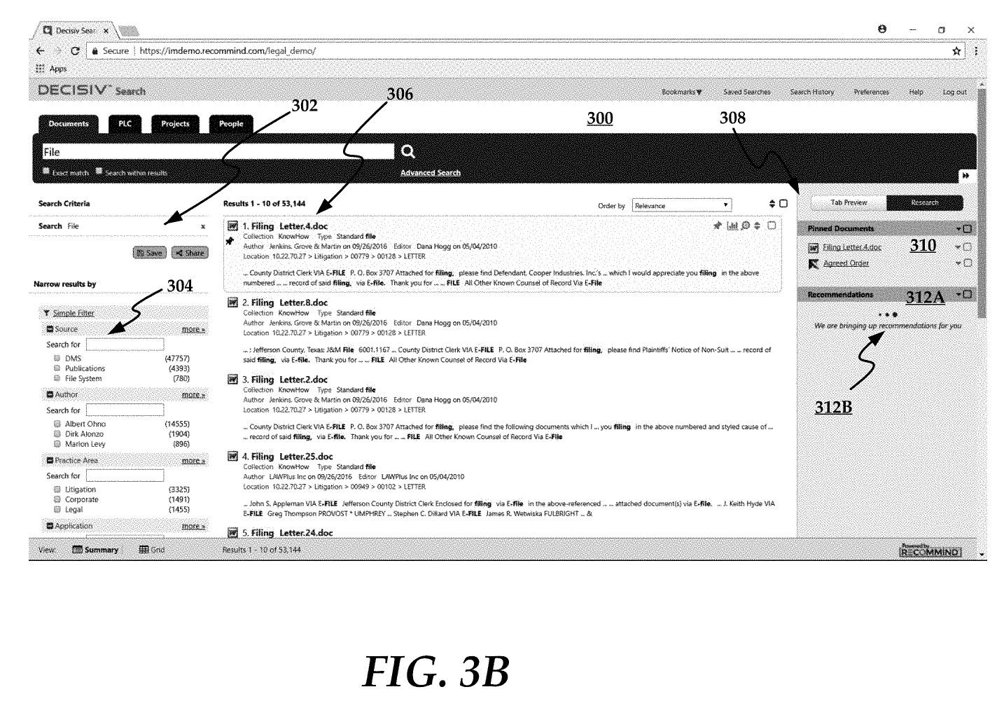

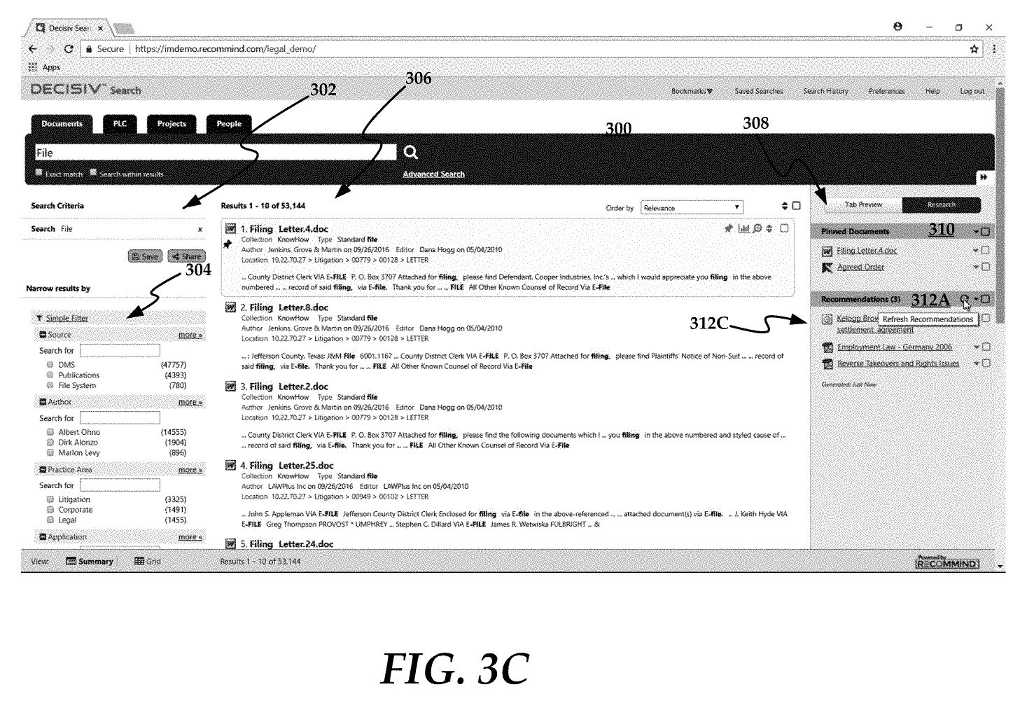

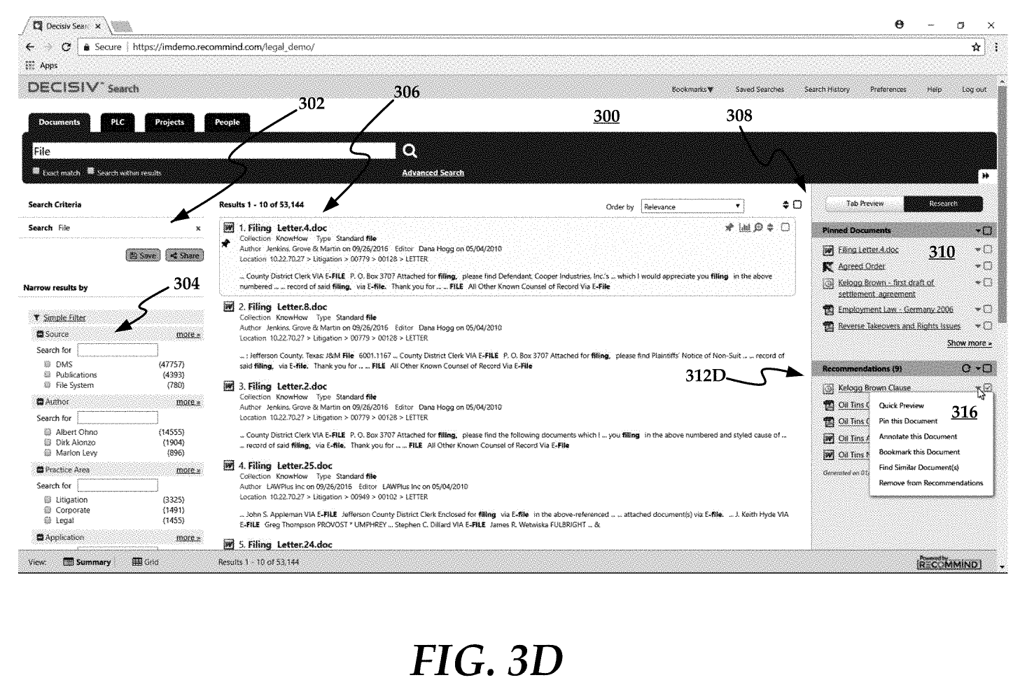

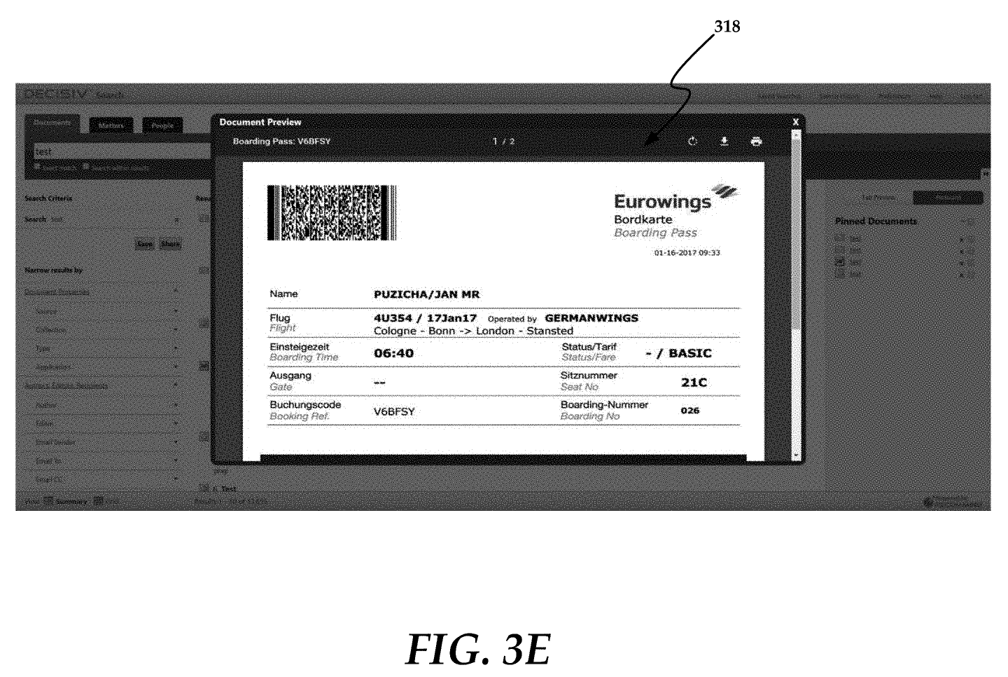

FIGS. 3A-E collectively illustrate example screenshots of a GUI 300 in the form of a document recommendation platform that allows a reviewer to input keywords or search constraints using a plurality of filters. The GUI also includes various panels that provide document review and pinning capabilities as will be discussed in greater detail. In some embodiments, the GUI 300 comprises search criteria panel 302 comprising a plurality of filters 304 that when applied to the corpus of documents generates the list of predictively coded documents. For example, filters allow a reviewer to search for source, author, practice area, and other similar document attributes.

Once selected, the system obtains documents and places a list of predictively coded documents (or other documents matched to the filter parameters) in a results panel 306. Each document in the results panel 306 includes identifying or descriptive information. The documents are ordered according to their relevancy in some embodiments.

Each of the documents in the results panel 306 can be pinned if desired by the reviewer. For example, document “filing letter 4” in the results panel 306 is pinned, as indicated by the pin icon 308.

Pinning of a document results in the document appearing in a pinned document list 310. Once at least one document has been pinned, the reviewer can actuate the system to generate a recommended set of documents 312 that appear below the pinned document list. The reviewer can review these recommended documents and either pin or remove them.

In one embodiment, the GUI 300 comprises an actuator 314, as shown in FIG. 3A, that is selectable when documents are in the pinned document list. In some embodiments, selection of the actuator 314 in recommend document list 312A initiates the generating of the recommended set of documents (312B in FIG. 3C) and populates the recommended set of documents 312C as illustrated in FIG. 3C. The reviewer can select one or more of the recommended documents in the recommended set of documents 312C as illustrated in FIG. 3C to generate a further recommended set of documents 312D as illustrated in FIG. 3D. As by way of example, and not to limit the inventive subject matter, in the embodiment illustrated in FIG. 3C, the reviewer selected the three recommended documents, resulting in the documents appearing in the pinned document list 310 as illustrated in FIG. 3D. To be sure, the recommended set of documents includes documents that may not have been discovered originally by the system when generated the list of documents in response to the search criteria specified by the reviewer.

In more detail, FIG. 3D illustrates optional operations that can be executed against the recommended set of documents 312D. For example, the reviewer is provided with a set of options 316 that includes generating a quick preview of the underlying recommended document. Another option is to pin the recommended document as described above. The reviewer can further annotate (e.g., code or tag) the document, as well as bookmark the document and execute a search for similar documents. The reviewer can also remove the recommended document, which effectively labels the document as a negative training example for the system.

FIG. 3E illustrates a popup 318 generated by the selection of a document. The popup 318 comprises a display of the underlying document in a near-native format. Thus, the reviewer can clearly review the document through this popup window in order to make a relevancy determination.

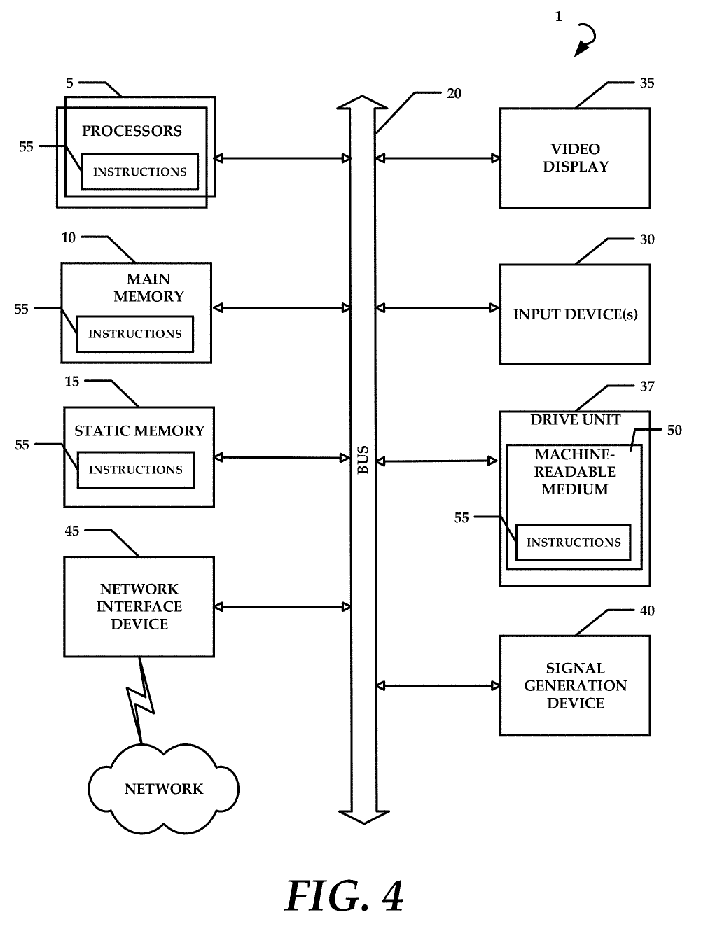

FIG. 4 is a diagrammatic representation of an example machine in the form of a computer system 1, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1 includes a processor or multiple processor(s) 5 (e.g., a central processing unit (CPU), a graphics processing unit (GPU), or both), and a main memory 10 and static memory 15, which communicate with each other via a bus 20. The computer system 1 may further include a video display 35 (e.g., a liquid crystal display (LCD)). The computer system 1 may also include input device(s) 30 (also referred to as alpha-numeric input device(s), e.g., a keyboard), a cursor control device (e.g., a mouse), a voice recognition or biometric verification unit (not shown), a drive unit 37 (also referred to as disk drive unit), a signal generation device 40 (e.g., a speaker), and a network interface device 45. The computer system 1 may further include a data encryption module (not shown) to encrypt data.

The drive unit 37 includes a machine-readable medium 50 (which may be a computer readable medium) on which is stored one or more sets of instructions and data structures (e.g., instructions 55) embodying or utilizing any one or more of the methodologies or functions described herein. The instructions 55 may also reside, completely or at least partially, within the main memory 10 and/or within the processor(s) 5 during execution thereof by the computer system 1. The main memory 10 and the processor(s) 5 may also constitute machine-readable media.

The instructions 55 may further be transmitted or received over a network via the network interface device 45 utilizing any one of a number of well-known transfer protocols (e.g., Hyper Text Transfer Protocol (HTTP)). While the machine-readable medium 50 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the disclosure as described herein.

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the present technology in the form disclosed. Many modifications and variations will be apparent to those of ordinary skill in the art without departing from the scope and spirit of the present technology. Exemplary embodiments were chosen and described in order to best explain the principles of the present technology and its practical application, and to enable others of ordinary skill in the art to understand the present technology for various embodiments with various modifications as are suited to the particular use contemplated.

Aspects of the present technology are described above with reference to flowchart illustrations and/or block diagrams of methods, apparatus (systems) and computer program products according to embodiments of the present technology. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present technology. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In the following description, for purposes of explanation and not limitation, specific details are set forth, such as particular embodiments, procedures, techniques, etc. in order to provide a thorough understanding of the present invention. However, it will be apparent to one skilled in the art that the present invention may be practiced in other embodiments that depart from these specific details.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

Also, some embodiments may be described in terms of “means for” performing a task or set of tasks. It will be understood that a “means for” may be expressed herein in terms of a structure, such as a processor, a memory, an I/O device such as a camera, or combinations thereof. Alternatively, the “means for” may include an algorithm that is descriptive of a function or method step, while in yet other embodiments the “means for” is expressed in terms of a mathematical formula, prose, or as a flow chart or signal diagram.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It is noted at the outset that the terms “coupled,” “connected”, “connecting,” “electrically connected,” etc., are used interchangeably herein to generally refer to the condition of being electrically/electronically connected. Similarly, a first entity is considered to be in “communication” with a second entity (or entities) when the first entity electrically sends and/or receives (whether through wireline or wireless means) information signals (whether containing data information or non-data/control information) to the second entity regardless of the type (analog or digital) of those signals. It is further noted that various figures (including component diagrams) shown and discussed herein are for illustrative purpose only, and are not drawn to scale.

While specific embodiments of, and examples for, the system are described above for illustrative purposes, various equivalent modifications are possible within the scope of the system, as those skilled in the relevant art will recognize. For example, while processes or steps are presented in a given order, alternative embodiments may perform routines having steps in a different order, and some processes or steps may be deleted, moved, added, subdivided, combined, and/or modified to provide alternative or sub-combinations. Each of these processes or steps may be implemented in a variety of different ways. Also, while processes or steps are at times shown as being performed in series, these processes or steps may instead be performed in parallel, or may be performed at different times.

While various embodiments have been described above, it should be understood that they have been presented by way of example only, and not limitation. The descriptions are not intended to limit the scope of the invention to the particular forms set forth herein. To the contrary, the present descriptions are intended to cover such alternatives, modifications, and equivalents as may be included within the spirit and scope of the invention as defined by the appended claims and otherwise appreciated by one of ordinary skill in the art. Thus, the breadth and scope of a preferred embodiment should not be limited by any of the above-described exemplary embodiments.

What is claimed is:

1. A method, comprising:
displaying on a graphical user interface, a list of predictively coded documents;
receiving an indication that a portion of the list of predictively coded documents are relevant to a user, the indication comprising a pinning of the portion of the list of predictively coded documents through user actuation received through the graphical user interface;
displaying the pinned portion of the list of predictively coded documents in a pinned document list;
applying text categorization to the pinned portion of the list of predictively coded documents;
obtaining a recommended set of documents from a corpus of documents based on the text categorization; and
displaying the recommended set of documents to the user on the graphical user interface.

2. The method according to claim 1, further comprising classifying the recommended set of documents as positive or negative based on user feedback.

3. The method according to claim 2, further comprising obtaining a new recommended set of documents from the corpus of documents based on the classification.

4. The method according to claim 3, further comprising generating a statistical classifier that obtains the new recommended set of documents using both the positive and negative user feedback.

5. The method according to claim 4, wherein the statistical classifier obtains the new recommended set of documents by predicting what documents are relevant based on an ordering of documents in a corpus based on a probability score.

6. The method according to claim 4, wherein the positive user feedback comprises pinning of at least a portion of the recommended set of documents.

7. The method according to claim 6, wherein the negative user feedback comprises removal of at least a portion of the recommended set of documents by a user.

8. The method according to claim 7, further comprising hiding negatively classified documents from user view.

9. The method according to claim 1, further comprising generating the graphical user interface, the graphical user interface comprising:
a search criteria panel comprising a plurality of filters that when applied to the corpus of documents generates the list of predictively coded documents;
a results panel that comprises the list of predictively coded documents;
a pinned document panel that comprises:
the pinned document list; and
the recommended set of documents.

10. The method according to claim 9, further comprising an actuator that is selectable when documents are in the pinned document list, wherein selection of the actuator populates the recommended set of documents.

11. A system comprising:
a processor; and
a memory for storing executable instructions, the processor executing the instructions to:
display on a graphical user interface, a list of predictively coded documents;
receive an indication that a portion of the list of predictively coded documents are relevant to a user, the indication comprising a pinning of the portion of the list of predictively coded documents through user actuation received through the graphical user interface;
display the pinned portion of the list of predictively coded documents in a pinned document list;
obtain a recommended set of documents from a corpus of documents based on text categorization using the pinned portion of the list of predictively coded documents as an input set; and
display the recommended set of documents to the user on the graphical user interface.

12. The system according to claim 11, wherein the processor is further configured to classify the recommended set of documents as positive or negative based on user feedback.

13. The system according to claim 12, wherein the processor is further configured to obtain a new recommended set of documents from the corpus of documents based on the classification.

14. The system according to claim 13, wherein the processor is further configured to generate a statistical classifier that obtains the new recommended set of documents using both the positive and negative user feedback.

15. The system according to claim 14, wherein the statistical classifier obtains the new recommended set of documents by predicting what documents are relevant based on an ordering of documents in a corpus based on a probability score.

16. The system according to claim 14, wherein the positive user feedback comprises pinning of at least a portion of the recommended set of documents.

17. The system according to claim 16, wherein the negative user feedback comprises removal of at least a portion of the recommended set of documents by a user.

18. The system according to claim 17, wherein the processor is further configured to hide negatively classified documents from user view.

19. The system according to claim 11, wherein the processor is further configured to generate the graphical user interface, the graphical user interface comprising:
a search criteria panel comprising a plurality of filters that when applied to the corpus of documents generates the list of predictively coded documents;
a results panel that comprises the list of predictively coded documents;
a pinned document panel that comprises:
the pinned document list; and
the recommended set of documents.

20. A method, comprising:
displaying on a graphical user interface, a list of predictively coded documents;
receiving an indication that a portion of the list of predictively coded documents are relevant to a user, the indication comprising a selection of the portion of the list of predictively coded documents through user actuation received through the graphical user interface;
displaying the selected portion of the list of predictively coded documents in a selected document list;
applying text categorization to the selected portion of the list of predictively coded documents;
obtaining a recommended set of documents from a corpus of documents based on the text categorization; and
displaying the recommended set of documents to the user on the graphical user interface.
